(19) United States
(12) Patent Application Publication
(10) Pub. No.: US 2010/0208807 A1
(43) Pub. Date: Aug. 19, 2010

(54) METHOD AND DEVICE FOR AVOIDING ROUNDING ERRORS AFTER PERFORMING AN INVERSE DISCRETE ORTHOGONAL TRANSFORMATION

(76) Inventor: Thomas SIKORA, Berlin (DE)

Correspondence Address: JOHN D. TITUS;DICKINSON WRIGHT PLLC, 5009 E. WASHINGTON, SUITE 125, PHOENIX, AZ, 85034, US

(21) Appl. No.: 12/706,499

(22) Filed: Feb. 16, 2010

(30) Foreign Application Priority Data
Feb. 18, 2009 (EP) 09153103.8

(51) Int. Cl. H04N 7/12

(52) U.S. Cl. 375/240.12; 375/240.18; 375/E07.076; 375/E07.027

(57) ABSTRACT

The present invention provides a method for avoiding rounding errors during rounding of values after performing an inverse discrete orthogonal transformation. In a first step, a block of coefficients (F′[u][v]) is transformed into a block of image pixel values (f′[y][x]) by means of an inverse discrete orthogonal transformation, wherein each image pixel comprises an image pixel value. In a second step, a product of the block of image pixel values (f′[y][x]) with a first pixel pattern (A[y][x]) is calculated. In a third step, the product values of the second step are summed up to a first sum (Sum1′). In a fourth step, it is determined whether the first sum (Sum1′) is even or odd. In a fifth step, if the first sum (Sum1′) is even, a block of manipulation values (C[y][x]) is added to or subtracted from the block of image pixel values (f′[y][x]) for generating a manipulated block of image pixel values (f[y][x]), wherein the block of manipulation values (C[y][x]) is formed in such a way that rounding errors are avoided in a subsequent rounding operation.

### CROSS-REFERENCE TO RELATED APPLICATIONS

This application claims priority to European application having application number EP 09153103.8, filed Feb. 18, 2009, which is incorporated herein by reference.

### FIELD OF THE INVENTION

The present invention relates to a method for avoiding rounding errors after performing an inverse discrete orthogonal transformation as well as to an encoding device and a decoding device which use this method.

### TECHNICAL BACKGROUND

Due to bandwidth limitations, a plurality of lossless and lossy encoding techniques for transmitting image and/or audio material is known, in order to reduce the amount of data to be transmitted. Many of the known coding methods use orthogonal transformation as for example the Fourier transformation or the cosine transformation.

From the MPEG-1 video standard (ISO/IEC 11172-2) and the MPEG-2 video standard (ISO/IEC 13818-2) different methods are known to make video material free from redundancies, to reduce its amount of data and to guarantee a safe transmission via an airlink or a storage device. The content of the MPEG-1 video standard (ISO/IEC 11172-2) and the MPEG-2 video standard (ISO/IEC 13818-2) are hereby enclosed by reference. Both MPEG standards require the use of the inverse discrete cosine transformation (IDCT) as inverse orthogonal transformation within the decoder. However, they do not specify the exact implementation, but only describe the needed accuracy.

Often after the calculation of the inverse discrete cosine transformation a rounding of the present real numbers to integer numbers is done. As the IEEE standard specification for the implementation of an 8×8 inverse discrete cosine transformation of 1990 describes—to which both the MPEG-1-standard and the MPEG-2-standard refer to—errors may appear during rounding of values, which are exactly between two integer numbers. It is known that encoders have an inverse path, which decodes an already encoded image. In this inverse path—like in the decoder—an inverse discrete Cosine Transformation is performed. If now values, which are exactly between two integer values, are rounded differently in the encoder compared to the decoder, a matching error is generated, as it is described in the IEEE specification.

MPEG-1 proposes for the reduction of such matching errors, that prior to the IDCT all coefficients are made odd numbered. Thereby the probability is reduced, that at the output IDCT values for image pixels appear, which are exactly between two integer numbers.

The EP 0 638 218 B1 describes a method to process a set of transformation coefficients and to provide an error-immune set of coefficients for the processing by an inverse orthogonal transformation. This error immune set of coefficients is according the EP 0 638 218 B1 immune against rounding errors during the inverse orthogonal transformation. In the method of the EP 0 638 218 B1 the coefficients in one set are summed up and the parity of the sum is checked (i.e. it is checked if the sum is odd numbered or even numbered). If it is shown that if the parity of the sum is even numbered, then the parity of one of the transform coefficients in the set is inverted to obtain a parity inverted transformation coefficient. The parity inverted transformation coefficient makes the parity of the sum odd numbered. Finally, the set of coefficients, including the parity inverted coefficient, is provided to the next following IDCT as an error-immune set.

The PCT/EP2007/009046 describes a method for avoiding rounding errors when values are rounded, after an inverse discrete cosine transformation has been performed. As in the method of EP 0 638 218 B1, the coefficient values of a block of coefficients are summed up and the parity of the sum is checked. In contrast to EP 0 638 218 B1, the adaptation of the coefficients is only performed after the IDCT, namely by adding or subtracting a block of manipulation values.

The JP H09-187 001 discloses a method for avoiding rounding errors when values are rounded, after an inverse discrete cosine transformation has been performed. Here, after an inverse discrete cosine transformation has been performed, an exactly calculated block of manipulation values is added to the image pixel values, before a rounding operation is done. In principle, the addition of the manipulation values block prior to the IDCT corresponds to a manipulation of the coefficient 7,7 prior to the IDCT. If mapping inaccuracies of the IDCT occur, this, however, leads to the undesired correction of other coefficients, wherein the coefficient 7,7 is predominantly changed.

### SUMMARY OF THE INVENTION

Starting from the prior art, it is the problem of the present invention to provide an improved method for avoiding rounding errors in the framework of performing an inverse discrete orthogonal transformation as well as an encoding device, a decoding device and a computer program which use this method.

According to the present invention, this problem is solved by a method for avoiding rounding errors according to claim 1, a method for providing a compressed video signal according to claim 9, a storage medium according to claim 10, a device for avoiding rounding errors according to claim 11, a decoder according to claim 12, an encoder according to claim 13 and a computer program according to claim 14. Preferred embodiments are described in the dependent claims.

In a preferred embodiment, the method for avoiding rounding errors during rounding of values after performing an inverse discrete orthogonal transformation comprises the following steps in the following order:

a) Transforming a block of coefficients (F′[u][v]) into a block of image pixel values (f′[y][x]) by means of an inverse discrete orthogonal transformation (preferably an IDCT), wherein each image pixel has one image pixel value;

b) calculating the product of the block of image pixel values (f′[y][x]) with a first pixel pattern (A[y][x]);

c) summing up the product values of step b) to a first sum (Sum1′);

d) determining whether the first sum (Sum1′) is even or odd; and

e) if the first sum (Sum1′) is even, adding or subtracting a block of manipulation values (C[y][x]) to the image pixel values of the block (f′[y][x]), in order to generate a manipulated block of image pixel values (f[y][x]), wherein the block of manipulation values (C[y][x]) is formed in such a way that rounding errors in subsequent rounding operations are minimized.

The method according to the present invention has the advantage that both the decision whether a correction of rounding errors should be done and the correction itself are only performed after the inverse discrete orthogonal transformation (e.g. an IDCT), i.e. in the area of image pixels. As a consequence, both the first pixel pattern A[y][x] and the manipulation values block C[y][x] can be adapted in an optimal way to the precision of the used IDCT algorithms.

Further, storing the value of the parity of the sum of coefficient values is no longer necessary, wherein in the prior art this value is determined prior to the inverse discrete orthogonal transformation. Additionally, this value does not have to be transferred in a complicated way, e.g. using additional hardware, to the device for avoiding rounding errors. The device can be integrated as self-contained module into the area of image pixels on the decoder and the encoder and does not have to use signals from the area of DCT coefficients, i.e. prior to the IDCT.

As the inverse discrete orthogonal transformation, in particular the IDCT, is performed in real applications only with finite precision, the requirements for the performance of a processor which does the determination of parity after the transformation and which adapts the coefficients are lower than in the prior art.

According to a further preferred embodiment of the method, the following steps are performed in step e), if the first sum (Sum1′) is even:

e1) Calculating a product of the block of image pixel values (f′[y][x]) with a second pixel pattern (B [y][x]);

e2) summing up the product values according to step e1) to a second sum (Sum2′); wherein

e3) if the second sum (Sum2′) is even, the block of manipulation values (C[y][x]) is added to the block of image pixel values (f′[y][x]); and

e4) if the second sum (Sum2′) is odd, the block of manipulation values (C[y][x]) is subtracted from the block of image pixel values (f′[y][x]).

The determination of the parity of the product of image pixel values with the second pixel pattern increases the certainty that rounding errors are avoided in the subsequent rounding. In this preferred embodiment, making recourse to the signals from the area of DCT coefficients (prior to the IDCT) is avoided, such that storing and transferring the signal prior to the IDCT is not needed.

Further, the product of the block of image pixel values with a second pixel pattern can be calculated in an easy and fast way, in particular as always the same matrix is used for the second pixel pattern. Thus, this type of case differentiation is very fast when implemented.

In a first preferred embodiment of the method, the first pixel pattern (A[y][x]) and/or the second pixel pattern (B[y][x]) and/or the block of manipulation values (C[y][x]) is a matrix which is optimized from a numerical or analytical point of view. In comparison to the prior art, many computational steps are no longer needed, if numerically or analytically optimized matrices are used such that the method for avoiding rounding errors performs significantly faster than with exactly calculated matrices. The used matrices can be further optimized in dependence on the precision of the implementation of the IDCT, wherein in spite of the usage of less computational steps the avoidance of rounding errors works equally well or better than with conventional methods for avoiding rounding errors. Using optimized matrices and avoiding rounding errors in the area of image pixels, it is no longer necessary to manipulate exactly one coefficient, e.g. the coefficient 7,7 such that the IDCT can often be stopped earlier which in turn leads to a lower number of computational steps to be performed.

In another preferred embodiment, the matrix of the first pixel pattern (A[y][x]) and/or of the second pixel pattern (B[y][x]) and/or of the block of manipulation reviews (C[y][x]) is numerally optimized by means of the gradient descent method and/or stochastic programming and/or analytically optimized by means of the Wiener filter method. Matrices which are optimized for the respective application can be generated by these methods numerically or analytically. In particular, these matrices can be adapted in an optimal way to the accuracy of the implementation of the IDCT.

In a preferred embodiment, the matrix of the first pixel pattern (A[y][x]) is the following matrix:

| | | | | | | | |
|---|---|---|---|---|---|---|---|
| 6.98 | −1.90 | 1.50 | −0.53 | 0.81 | −0.08 | 0.47 | 0.21 |
| −1.90 | 0.52 | −0.41 | 0.15 | −0.22 | 0.00 | −0.13 | −0.06 |
| 1.51 | −0.41 | 0.33 | −0.12 | 0.18 | −0.00 | 0.10 | 0.05 |
| −0.53 | 0.15 | −0.15 | 0.00 | −0.06 | 0.00 | −0.00 | −0.00 |
| 0.82 | −0.22 | 0.18 | −0.06 | 0.10 | −0.00 | 0.06 | 0.00 |
| −0.08 | 0.00 | −0.00 | 0.00 | −0.00 | 0.00 | −0.00 | −0.00 |
| 0.47 | −0.13 | 0.10 | −0.00 | 0.06 | −0.00 | 0.00 | 0.00 |
| 0.21 | −0.06 | 0.05 | −0.00 | 0.00 | −0.00 | 0.00 | 0.00 |

In a preferred embodiment, the second pixel pattern (B[y][x]) consists of a quadratic symmetric matrix, preferably the following matrix:

| | | | | | | | |
|---|---|---|---|---|---|---|---|
| 0.0095 | −0.0271 | 0.0406 | −0.0478 | 0.0478 | −0.0406 | 0.0271 | −0.0095 |
| −0.0271 | 0.0772 | −0.1155 | 0.1362 | −0.1362 | 0.1155 | −0.0772 | 0.0271 |
| 0.0406 | −0.1155 | 0.1728 | −0.2039 | 0.2039 | −0.1728 | 0.1155 | −0.0406 |
| −0.0478 | 0.1362 | −0.2039 | 0.2405 | −0.2405 | 0.2039 | −0.1362 | 0.0478 |
| 0.0478 | −0.1362 | 0.2039 | −0.2405 | 0.2405 | −0.2039 | 0.1362 | −0.0478 |
| −0.0406 | 0.1155 | −0.1728 | 0.2039 | −0.2039 | 0.1728 | −0.1155 | 0.0406 |
| 0.0271 | −0.0772 | 0.1155 | −0.1362 | 0.1362 | −0.1155 | 0.0772 | −0.0271 |
| −0.0095 | 0.0271 | −0.0406 | 0.0478 | −0.0478 | 0.0406 | −0.0271 | 0.0095 |

In a preferred embodiment, the manipulation values block (C[y][x]) consists of a quadratic symmetric matrix, preferably the following matrix:

| | | | | | | | |
|---|---|---|---|---|---|---|---|
| 0.0000 | 0.0000 | 0.0000 | 0.0000 | 0.0000 | 0.0000 | 0.0000 | 0.0000 |
| 0.0000 | 0.0000 | −0.1155 | 0.1362 | −0.1362 | 0.1155 | 0.0000 | 0.0000 |
| 0.0000 | −0.1155 | 0.1728 | −0.2039 | 0.2039 | −0.1728 | 0.1155 | 0.0000 |
| 0.0000 | 0.1362 | −0.2039 | 0.2405 | −0.2405 | 0.2039 | −0.1362 | 0.0000 |
| 0.0000 | −0.1362 | 0.2039 | −0.2405 | 0.2405 | −0.2039 | 0.1362 | 0.0000 |
| 0.0000 | 0.1155 | −0.1728 | 0.2039 | −0.2039 | 0.1728 | −0.1155 | 0.0000 |
| 0.0000 | 0.0000 | 0.1155 | −0.1362 | 0.1362 | −0.1155 | 0.0000 | 0.0000 |
| 0.0000 | 0.0000 | 0.0000 | 0.0000 | 0.0000 | 0.0000 | 0.0000 | 0.0000 |

In another preferred embodiment of the method, the first pixel pattern (A[y][x]) is a matrix which consists of the sum of basis images of the DCT (F′[u][v]) at the particular position ([y][x]).

In a further preferred embodiment of the method, the second pixel pattern (B[y][x]) is a matrix which consists of the basis image of the DCT for the coefficient F′[7][7].

In a further preferred embodiment of the method, the method further comprises the following step:

f) Rounding each manipulated image pixel value in the manipulated block of image pixel values (f[y][x]) to an integer number.

In a preferred embodiment, a method for providing a compressed video signal comprises the following steps:

a) performing a prediction coding by means of comparing subsequent images;

b) transforming image blocks into blocks of transformation coefficients by means of a discrete cosine transformation.

c) performing the above-described method for avoiding rounding errors in an inverse branch of an encoder in which an encoded image is decoded.

Using this method, a compressed video signal is provided by an encoder which offers the advantages of the coding according to the present invention.

In a preferred embodiment, the compressed video signal which has been encoded by means of the above-described method is stored in the storage medium.

A further preferred embodiment is a device for avoiding rounding errors during rounding of values after performing an inverse discrete orthogonal transformation, wherein the device comprises means for performing the method according to the present invention.

In a preferred embodiment, the method for avoiding rounding errors according to the present invention is performed in a decoder.

In a preferred embodiment, the method for avoiding rounding errors according to the present invention is performed in an encoder.

In a preferred embodiment, a computer program comprises instructions such that it performs the steps of the method according to the present invention when it runs on a computer.

### SHORT DESCRIPTION OF THE FIGURES

The enclosed figures only serve for illustration purposes and for a better understanding of the present invention and its advantages. It is shown in:

FIG. 1 a schematic view of an encoder in which the present invention is used;

FIG. 2 a schematic view of a decoder in which the present invention is used;

FIG. 3 a schematic view of the arrangement of avoiding the rounding errors in an encoder/decoder;

FIG. 4 a schematic view of avoiding the rounding errors according to the present invention;

FIG. 5 an illustration of a first pixel pattern according to the present invention;

FIG. 6 an illustration of an optimized first pixel pattern according to the present invention;

FIG. 7 an illustration of a second pixel pattern according to the present invention;

FIG. 8 an illustration of a block of manipulation values according to the present invention;

FIG. 9 a flow diagram which illustrates the method for avoiding rounding errors according to the present invention; and

FIG. 10 a flow diagram which illustrates a method for optimizing the matrices used in avoiding rounding errors.

### DETAILED DESCRIPTION OF PREFERRED EMBODIMENTS

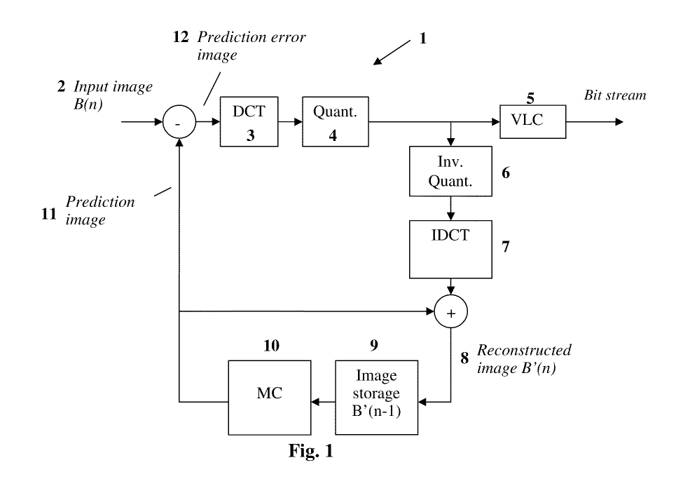

FIG. 1 schematically shows the structure of a typical video encoder 1. One possibility for encoding video images is e.g. an encoding according to MPEG. For illustrative purposes, the following description is given in the framework of video encoding according to MPEG without limiting the range of applications of the present inventions to such a coding. The MEPG-2-standard provides three different types of images for the coding, namely I, P and B images. I images are encoded independent from the other images; they are submitted to a so called intra-coding. P images are predicated from a preceding I image or P image; they thus depend on an I image or P image which precedes in time. B images can depend on a preceding and/or a subsequent I or P image.

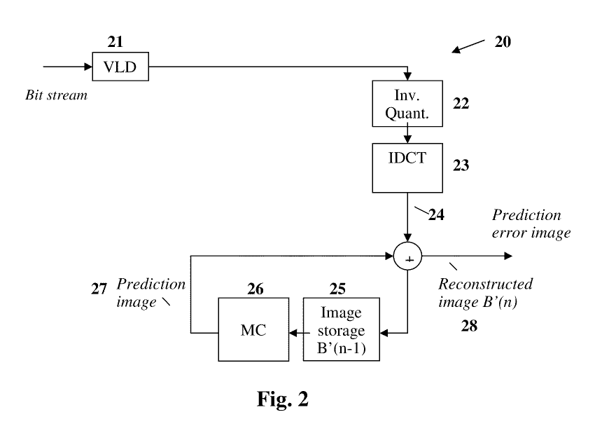

If a video encoder 1 as it is illustrated in FIG. 1 is used for such an MPEG coding of e.g. P images, not the input image, but a prediction error image 12 is encoded and transmitted. From an already transmitted image within an image memory 9 a prediction image 11 is generated by means of motion compensation (MC) 10. Displacements from one image to another image are described by motion vectors. The difference of input image 2 and prediction image 11 results in the prediction error image 12. The pixel values of the prediction error image 12 are transformed by means of DCT 3 and result in a block of transformation coefficients. These are quantized in a quantizer 4. The quantized transformation coefficients and the motion vectors are converted into code words by means of a VLC (variable length coder) 5 and result in the bit stream for storage or transmission. Each image sent to the decoder 20 must also be present as exact as possible in the encoder 1 within image memory 9 for the next prediction. Due to this reason, the encoder 1 comprises also a local decoder, which reconstructs the decoder image B′(n) 8. The local decoder comprises an inverse quantizer 6 and a device for performing an inverse discrete cosine transformation (IDCT) 7. The inventive method for avoiding rounding errors during rounding of values after performing the inverse discrete orthogonal transformation, here in particular the IDCT, is performed in the area of the local decoder which comprises the inverse quantizer 6 and the IDCT 7. A comparison with FIG. 2 shows that the local decoder blocks of the encoder in principle correspond to the blocks of the decoder.

FIG. 2 schematically shows the basic structure of a typical video decoder 20. The incoming bit stream transports—among others—information about the motion vectors and the prediction error images. A variable length decoder (VLD) 21 converts the bit stream into quantizer values and motion vectors. The quantizer values are converted by the inverse quantizer 22 into a block of transformation coefficients and after that into pixels of the prediction error image 24 by means of an IDCT 23. The reconstructed image 28 results from an addition of the prediction image 27 and the prediction error image 24. The prediction image 27 is generated by means of motion compensation (MC) 26 from the previous reconstructed image which is stored in the image memory 25. As in the encoder 1, also the decoder 20 uses the method according to the present invention for avoiding rounding errors during rounding of values after performing the IDCT in the area of the IDCT 23.

As it is shown in FIGS. 1 and 2, the encoder 1 as well as the decoder 20 comprises an IDCT block 7, respectively 23. Pixel values (which are also called image pixel values) are reconstructed from the coefficients, which are submitted to the inverse quantisation by means of the IDCT. This calculation is done with a finite accuracy.

In order to reduce the computational and storage effort in the course of the further processing, the pixel values obtained by the IDCT 7, 23 are rounded. Preferably each pixel value is rounded to an integer number. Such a rounding step is performed in encoder 1 and in decoder 20. The implementation of the IDCT 7, 23 as well as the subsequent rounding operations can, however, be different in encoder 1 and in decoder 20, since e.g. they are produced by different manufacturers. Due to such different implementations, different results can occur for values, which are in a small range exactly between two values to which they can be rounded. Therefore, it can depend on the implementation of the rounding operation and of the IDCT—in particular its accuracy—, if a value is rounded up or rounded off. If a different value appears in encoder 1 and in decoder 20 after the rounding, this is called an adaptation error.

FIG. 3 describes the arrangement of the device for avoiding rounding errors 30 in the area of the local decoder of encoder 1 or of decoder 20. This makes it clear that the entire method which is performed by device 30 is positioned after the device for performing the IDCT 7, 23 and prior to rounding device 40. As device 30 is arranged as a module after the IDCT device 7, 23, it does not need any information from DCT signals. As a result, the device for avoiding rounding errors 30 needs neither a physical connection for receiving the DCT signals which would have to bypass the IDCT device 7, 23 nor a separate storage has to be provided which stores the result of a determination of the parity of the DCT signal for avoiding rounding errors. The module 30 is autarchic from a signal processing point of view and has only the image pixel values f′[y][x] as input values.

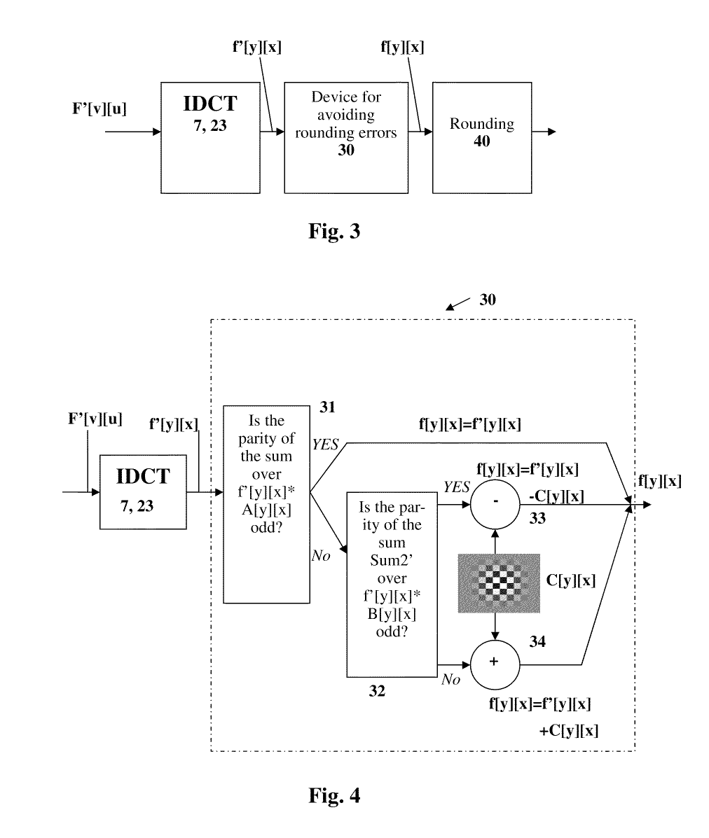

FIG. 4 describes a preferred embodiment of the device for the avoidance of rounding errors 30 according to the present invention by which the occurrence of adaption errors can be reduced. A block of coefficient values F′[u][v] is subjected to the IDCT 7, 23. It is noted that the IDCT is only an example for an inverse discrete orthogonal transformation of the coefficients F′[u][v] which is generally usable according to the present invention. The result of the IDCT 7, 23 is a block of image pixel values f′[y][x] which are preferably real numbers with finite precision.

Then, a first sum Sum1′ is calculated over the values of the product of the block of image pixel values f′[v][u] with a first pixel pattern A[y][x]. Then, it is determined in device 31 for the determination of the parity whether the value of the first sum Sum1′ is even or odd. If the first sum Sum1′ is an odd number, the image pixel values remain unchanged, it holds f[y][x]=f′[y][x]. If, however, the first sum Sum1′ is even, additionally a second sum Sum2′ is calculated over the values of the product of the block of image pixel values f′[y][x] with a second pixel pattern B[y][x], and the sum is evaluated in a device 32 for the determination of parity. If the value of this second sum Sum2′ is even, a block of manipulation values C[y][x] is added to the block of image pixel values f′[y][x] by an adder/subtractor 32, in order to obtain a manipulated image pixel value block, f[y][x]=f′[y][x]+C[y][x]. If the value of this second sum Sum2′ is odd, a block of manipulation values C[y][x] is subtracted from the block of image pixel values f′[y][x] by an adder/subtractor 32, in order to obtain a manipulated image pixel value block, f[y][x]=f′[y][x]−C[y][x].

The manipulated image pixel values f[y][x] are subsequently rounded. Due to the manipulation of the image pixel values, it is avoided that image pixel values lie exactly between two integer values or in a small area exactly in between two integer values. Thereby, the result of the rounding operation is independent from the implementation of the IDCT 7, 23 and from the subsequent rounding operation, whereby the occurrence of adaptation errors is avoided by the present invention. Thus, the IDCT is robust against rounding errors.

In the embodiment according to FIG. 4, an 8×8 fixed image pattern C[y][x] is superimposed to the reconstructed pixel values in the 8×8 block f′[y][x], if the sum of the coefficient values of the product of the block of image pixel values f′[y][x] with a first pixel pattern A[y][x] is even (wherein y and x are integer numbers in the range 0, 1, . . . 7). The rounding to integer values is performed on the basis of the manipulated image pixel values f[y][x].

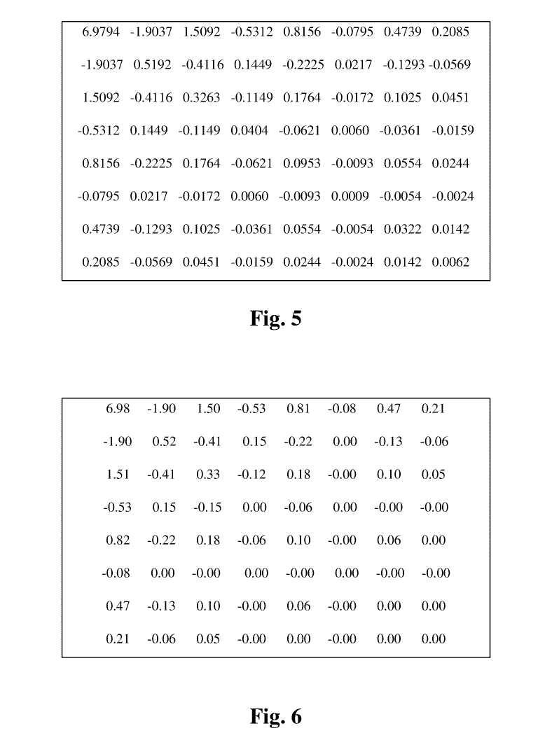

FIG. 5 shows an example for a first pixel pattern as it can be used in the framework of the present invention. The values are rounded to four fractional digits for reasons of clarity. The example of FIG. 5 should not be understood as limiting, but it should only illustrate a particularly advantageous pixel pattern. The example of FIG. 5 also makes it clear that preferably a quadratic matrix A[y][x] of the size 8×8 which is symmetric is used in the framework of an 8×8 IDCT.

FIG. 6 shows the example of a first pixel pattern from FIG. 5, wherein the values have been numerically optimized.

FIG. 7 shows an example for a second pixel pattern B[y][x], as it can be used in the framework of the present invention. The values are rounded to four fractional digits for reasons of clarity. The example of FIG. 7 should also not be understood as limiting, but should only describe a particularly advantageous second pixel pattern. The example of FIG. 7 also makes it clear that preferably a quadratic matrix B[y][x] of the size 8×8 which is symmetric is used in the framework of an 8×8 IDCT. The signs of the particular values are arranged in a checker board pattern, wherein the value in the upper left corner has a positive sign. Further, the absolute values of the shown matrix decrease along the outward direction.

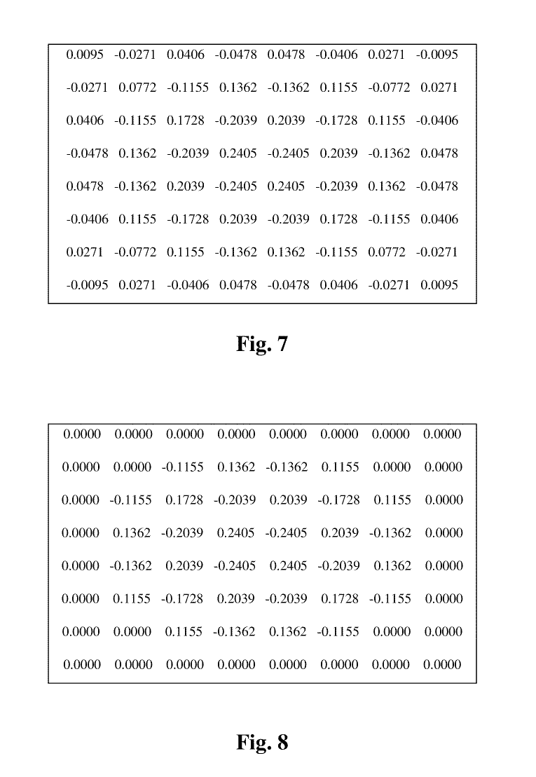

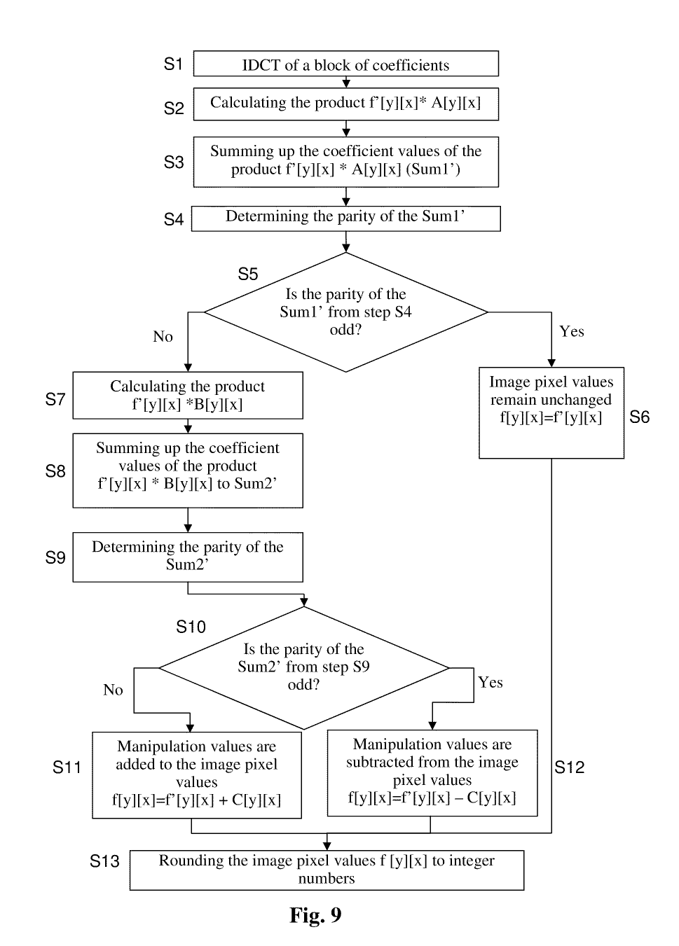

FIG. 8 shows an example for a block of manipulation values C[y][x], as it can be used in the framework of the present invention. The values are also rounded to four fractional digits for reasons of clarity. The example of FIG. 8 should not be understood as limiting but it should only describe a particularly advantageous block of manipulation values. The exact values to be used can be generated for example by a numeric optimization. The example of the numerically optimized matrix of FIG. 8 also makes it clear that preferably a quadratic matrix of manipulation values C[y][x] of the size 8×8 which is symmetric is used in the framework of an 8×8 IDCT. The signs of the various values are arranged in a checker board pattern, wherein the value in the upper left corner has a positive sign. Further, the absolute values of the illustrated matrix decrease along the outward direction.

FIG. 9 shows a flow diagram in which the sequence of the method according to the present invention, as it is used in encoder 1 and decoder 20, is illustrated.

In step S1, the coefficients F′[v][u] are transformed into a block of image pixel values f′[y][x] by means of IDCT 7 or 23. In step S2, the product of the block of image pixel values f′[y][x] with a first pixel pattern A[y][x] is calculated. The first pixel pattern A[y][x] is a matrix with values allowing that the block of image pixel values f′[y][x] after the IDCT can be checked with respect to parity. A typical embodiment for such a matrix is given in FIGS. 5 and 6.

Mathematically, A[y][x] in FIG. 5 is e.g. the sum of basis images of the DCT (the IDCT, respectively) at the position [y][x] and results as follows, wherein IB[y][x][u][v] is the [u][v]^{th} basis image of the DCT (the IDCT, respectively) at the position [y][x]:

$$\begin{matrix}{\sum }_{u = 0}^{7} {\sum }_{v = 0}^{7} {F}^{′} [ u ] [ v ] = {\sum }_{y = 0}^{7} {\sum }_{x = 0}^{7} {f}^{′} [ y ] [ x ] \cdot {\sum }_{u = 0}^{7} {\sum }_{v = 0}^{7} {I}_{B} [ u ] [ v ] [ y ] [ x ] \\ ⇔ A [ y ] [ x ] = {\sum }_{u = 0}^{7} {\sum }_{v = 0}^{7} {I}_{B} [ u ] [ v ] [ y ] [ x ]\end{matrix}$$

A[y][x] in FIG. 6, however, differs from the mathematically calculated matrix and has been optimized with a numerical or analytical method, in order to ensure a robust avoiding of rounding errors with a small computational effort at the same time.

For example, the gradient descent method or a stochastic optimization can be used for a numerical optimization of the used matrices. For example, the Wiener filter method can be used for an analytic optimization of the used matrices.

In step S3, the coefficient values of the product in step 4 are summed up, i.e. the first sum Sum1′ is calculated. In step S4, the parity of the first sum Sum1′ is determined. If the parity of the first sum Sum1′ is odd, step S6 follows and the image pixel values remain unchanged, it holds f[y][x]=f′[y][x]. If, however, the first sum Sum1′ is even, additionally the product of the block of image pixel values f′[y][x] with a second pixel pattern B[y][x] is calculated in step S7.

A typical embodiment for such a matrix is given in FIG. 7. Mathematically, B[y][x] of FIG. 7 is the [7][7]^{th} basis image of the DCT (the IDCT, respectively) at the position [y][x] and results as follows:

$$\begin{matrix}{F}^{′} [ 7 ] [ 7 ] = {\sum }_{y = 0}^{7} {\sum }_{x = 0}^{7} {f}^{′} [ y ] [ x ] \cdot {I}_{B} [ 7 ] [ 7 ] [ y ] [ x ] \\ ⇔ B [ y ] [ x ] = {I}_{B} [ 7 ] [ 7 ] [ y ] [ x ]\end{matrix}$$

As described above, B[y][x] can deviate from the mathematically calculated matrix and preferably can be optimized with a numeric or analytic method, in order to ensure a robust avoidance of rounding errors with a small computational effort at the same time.

In step S8, a second sum Sum2′ over the coefficient values of the product of the block of image pixel values and the second pixel pattern (B[y][x]) is calculated. Again, it is determined in step S9, whether the value of the second sum Sum2′ is even or odd. If the second sum Sum2′ is even, a block of manipulation values C[y][x] is added to the block of image pixel values f′[y][x] in step S11, f[y][x]=f′[y][x]+C[y][x]. If the second sum Sum2′ is odd, the block of manipulation values C[y][x] is subtracted from it in step S12, f[y][x]=f′[y][x]-C[y][x], in order to obtain a manipulated block of image pixel values.

An example for a block of manipulation values C[y][x] is given in FIG. 8. The block of manipulation values C[y][x] in FIG. 8 has also been optimized by means of a numeric or analytic method, in order to ensure a robust avoidance of rounding errors with a small computational effort at the same time.

Subsequently to the steps S11, S12 and S7, the manipulated image pixel values f[y][x] are rounded in step S13. Here, each number for which the first fractional digit is greater or equal 5 is rounded to the next greater integer value, while each number for which the first fractional digit is smaller than 5 is rounded to the next smaller integer number. The manipulation of the image pixel values avoids that image pixel values lie exactly between two integer values or in a small region exactly in between integer values. As a result of this, the result of the rounding operations becomes independent from the implementation of the IDCT 7, 23 and the subsequent rounding operation such that the present invention minimizes the occurrence of adaptation errors.

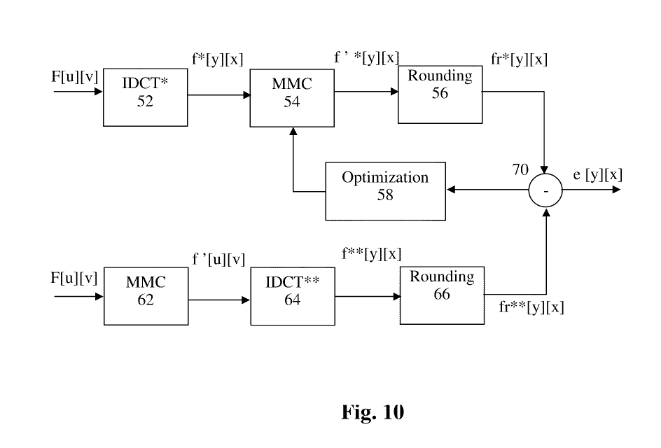

It is shown in FIG. 10 how a numeric or analytic optimization of the used matrices A[y][x], B[y][x] and C[y][x] can be tested.

In the upper part of FIG. 10, method steps 52, 54 and 56 represent the IDCT 52 with avoiding rounding errors according to the present invention (MMC=Mismatch Control) 54 and rounding 56 of an encoder. The lower part of FIG. 10 represents the conventional MPEG2 avoidance of rounding errors 62 of a decoder prior to the IDCT 64 and subsequent rounding 66. Here, the IDCT* 64 can be implemented in a different way than the IDCT** 52, in particular it can have different precision.

Using an identical incoming coefficient bit stream F[u][v], the inventive method first performs an IDCT 52 and then avoiding rounding errors 54 in the pixel area, before the real rounding 56 is performed. The conventional MPEG2 method first performs the avoidance of rounding errors 62 in the area of coefficients and then performs the IDCT 64, before the real rounding 66 is done. In order to optimize the matrices A[y][x], B[y][x] and C[y][x] which are used in the avoidance of rounding errors 54, the respective results of both IDCT methods are compared with each other and an error e[y][x] is calculated. Then, a numerical or analytical optimization of matrices A[y][x], B[y][x] and C[y][x] is done in block 58, until the resulting error e[y][x] is minimized.

In this way, the optimal matrices A[y][x], B[y][x] and C[y][x] can be determined for encoding according to the method of the present invention.

What is claimed is:

1. Method for avoiding rounding errors during rounding of values after performing an inverse discrete orthogonal transformation (7, 23), wherein the method comprises the following steps in the following order:
a) Transforming a block of coefficients (F′[u][v]) into a block of image pixel values (f′[y][x]) by means of an inverse discrete orthogonal transformation (7, 23), wherein each image pixel comprises a image pixel value (S1).
b) Calculating a product of the block of image pixel values (f′[y][x]) with a first pixel pattern (A[y][x]) (S2);
c) summing up the product values of step b) (S3) to a first sum (Sum1′);
d) determining whether the first sum (Sum1′) is even or odd (S4); and
e) if the first sum (Sum1′) is even, adding or subtracting a block of manipulation values (C[y][x]) to the block of image pixel values (f′[y][x]) for generating a manipulated block of image pixel values (f[y][x]), wherein the block of manipulation values (C[y][x]) is formed in such a way that rounding errors in a subsequent rounding operation are minimized (S11, S12, S13).

2. Method according to claim 1, wherein in step (e) the following steps are performed, if the first sum (Sum1′) is even:
e1) Calculating a product of the block of image pixel values (f′[y][x]) with a second pixel pattern (B[y][x]) (S7);
e2) summing up the product values from step e1) (S8) to a second sum (Sum2′); wherein
e3) if the second sum (Sum2′) is even (S9, S10), the block of manipulation values (C[y][x]) is added to the block of image pixel values (f′[y][x]) (S11); and
e4) if the second sum (Sum2′) is odd (S9, S10), the block of manipulation values (C[y][x]) is subtracted from the block of image pixel values (S12).

3. Method according to claim 1, wherein the first pixel pattern (A[y][x]), the second pixel pattern (B[y][x]) or the block of manipulation values (C[y][x]), or any combination thereof is a numerically or analytically optimized matrix.

4. Method according to claim 3, wherein the matrix of the first pixel pattern (A[y][x]), the matrix of the second pixel pattern (B [y][x]) or the matrix of the block of manipulation values (C[y][x]), or any combination thereof, is numerically optimized by the gradient descent method; or stochastic programming; or analytically optimized by the Wiener filter method, or any combination thereof.

5. Method according to claim 1, wherein the matrix of the first pixel pattern (A[y][x]) is the following matrix:

| | | | | | | | |
|---|---|---|---|---|---|---|---|
| 6.98 | −1.90 | 1.50 | −0.53 | 0.81 | −0.08 | 0.47 | 0.21 |
| −1.90 | 0.52 | −0.41 | 0.15 | −0.22 | 0.00 | −0.13 | −0.06 |
| 1.51 | −0.41 | 0.33 | −0.12 | 0.18 | −0.00 | 0.10 | 0.05 |
| −0.53 | 0.15 | −0.15 | 0.00 | −0.06 | 0.00 | −0.00 | −0.00 |
| 0.82 | −0.22 | 0.18 | −0.06 | 0.10 | −0.00 | 0.06 | 0.00 |
| −0.08 | 0.00 | −0.00 | 0.00 | −0.00 | 0.00 | −0.00 | −0.00 |
| 0.47 | −0.13 | 0.10 | −0.00 | 0.06 | −0.00 | 0.00 | 0.00 |
| 0.21 | −0.06 | 0.05 | −0.00 | 0.00 | −0.00 | 0.00 | 0.00 |

6. Method according to claim 2, wherein the second pixel pattern (B[y][x]) consists of a quadratic symmetric matrix.

7. Method according to claim 1, wherein the block of manipulation values (C[y][x]) consists of a quadratic symmetric matrix.

8. Method according to claim 1, wherein the method further comprises the following step:
f) Rounding each manipulated image pixel value of the manipulated block of image pixel values (f[y][x]) to an integer number (S13).

9. Method for providing a compressed video signal comprising the following steps:
a) Performing a prediction coding by means of a comparison of subsequent images;
b) transforming image blocks into blocks of transformation coefficients by means of a discrete cosine transformation;
c) performing the method for avoiding rounding errors according to claim 1 in an inverse branch of an encoder in which an encoded image is decoded.

10. A storage medium in which the compressed video signal according to claim 9 is stored.

11. Device for avoiding rounding errors (30) during rounding of values after performing an inverse discrete orthogonal transformation (7, 23), wherein the device comprises means for performing the method according to claim 1.

12. Decoder (1), in which the method according to claim 1 is performed for avoiding rounding errors.

13. Encoder (20) in which the method according to claim 1 is performed for avoiding rounding errors.

14. Computer program comprising instructions which performs the steps of the method according to claim 1 when running on a computer.

15. Method according to claim 2, wherein the second pixel pattern (B[y][x]) consists of the following matrix:

| | | | | | | | |
|---|---|---|---|---|---|---|---|
| 0.0095 | −0.0271 | 0.0406 | −0.0478 | 0.0478 | −0.0406 | 0.0271 | −0.0095 |
| −0.0271 | 0.0772 | −0.1155 | 0.1362 | −0.1362 | 0.1155 | −0.0772 | 0.0271 |
| 0.0406 | −0.1155 | 0.1728 | −0.2039 | 0.2039 | −0.1728 | 0.1155 | −0.0406 |
| −0.0478 | 0.1362 | −0.2039 | 0.2405 | −0.2405 | 0.2039 | −0.1362 | 0.0478 |
| 0.0478 | −0.1362 | 0.2039 | −0.2405 | 0.2405 | −0.2039 | 0.1362 | −0.0478 |
| −0.0406 | 0.1155 | −0.1728 | 0.2039 | −0.2039 | 0.1728 | −0.1155 | 0.0406 |
| 0.0271 | −0.0772 | 0.1155 | −0.1362 | 0.1362 | −0.1155 | 0.0772 | −0.0271 |
| −0.0095 | 0.0271 | −0.0406 | 0.0478 | −0.0478 | 0.0406 | −0.0271 | 0.0095 |

16. Method according to claim 1, wherein the block of manipulation values (C[y][x]) consists of the following matrix:

| | | | | | | | |
|---|---|---|---|---|---|---|---|
| 0.0000 | 0.0000 | 0.0000 | 0.0000 | 0.0000 | 0.0000 | 0.0000 | 0.0000 |
| 0.0000 | 0.0000 | −0.1155 | 0.1362 | −0.1362 | 0.1155 | 0.0000 | 0.0000 |
| 0.0000 | −0.1155 | 0.1728 | −0.2039 | 0.2039 | −0.1728 | 0.1155 | 0.0000 |
| 0.0000 | 0.1362 | −0.2039 | 0.2405 | −0.2405 | 0.2039 | −0.1362 | 0.0000 |
| 0.0000 | −0.1362 | 0.2039 | −0.2405 | 0.2405 | −0.2039 | 0.1362 | 0.0000 |
| 0.0000 | 0.1155 | −0.1728 | 0.2039 | −0.2039 | 0.1728 | −0.1155 | 0.0000 |
| 0.0000 | 0.0000 | 0.1155 | −0.1362 | 0.1362 | −0.1155 | 0.0000 | 0.0000 |
| 0.0000 | 0.0000 | 0.0000 | 0.0000 | 0.0000 | 0.0000 | 0.0000 | 0.0000 |
